(19) United States
(12) Patent Application Publication
(10) Pub. No.: US 2014/0043252 A1
(43) Pub. Date: Feb. 13, 2014

(54) TOUCHSCREEN PANEL AND TOUCHSCREEN DEVICE

(71) Applicant: SAMSUNG ELECTRO-MECHANICS CO., LTD., Suwon (KR)

(72) Inventors: Hyun Jun KIM, Suwon (KR); Kyung Hee Hong, Suwon (KR); Tah Joon Park, Suwon (KR)

(73) Assignee: SAMSUNG ELECTRO-MECHANICS CO., LTD., Suwon (KR)

(21) Appl. No.: 13/656,825

(22) Filed: Oct. 22, 2012

(30) Foreign Application Priority Data
Aug. 9, 2012 (KR) 10-2012-0087383

(51) Int. Cl. G06F 3/041

(52) U.S. Cl. CPC G06F 3/041
USPC 345/173

(57) ABSTRACT

There is provided a touchscreen panel including: a plurality of first electrodes formed on a substrate and including a plurality of first unit electrodes connected in a first axial direction; and a plurality of second electrodes formed on the substrate and including a plurality of second unit electrodes connected in a second axial direction perpendicular to the first axial direction, wherein a plurality of slits having a curved shape are formed between the plurality of first and second electrodes, part of the first unit electrodes and part of the second unit electrodes are included in a unit sensing cell having a rectangular shape, and a virtual slit obtained by rotating a slit formed in a direction toward a corner of the unit sensing cell from a center of the unit sensing cell by 90 degrees is identical to a slit formed in a direction toward another corner adjacent thereto.

### CROSS-REFERENCE TO RELATED APPLICATIONS

This application claims the priority of Korean Patent Application No. 10-2012-0087383 filed on Aug. 9, 2012, in the Korean Intellectual Property Office, the disclosure of which is incorporated herein by reference.

### BACKGROUND OF THE INVENTION

1. Field of the Invention

The present invention relates to a touchscreen panel and a touchscreen device.

2. Description of the Related Art

Touch sensing devices such as touchscreens, touch pads, and the like, are input devices attached to display devices which provide users with intuitive data input methods, and have recently been applied to various electronic devices such as cellular phones, personal digital assistants (PDAs), vehicle navigation devices, and the like. In particular, as demand for smart phones has recently increased, touchscreens have been increasingly employed as touch sensing devices capable of providing various input methods in a limited form factor.

Touchscreens applied to portable devices can be classified into resistive-type touchscreens and capacitive-type touchscreens according to methods of sensing a touch input. Capacitive-type touchscreens have advantageously long lifespans and various input methods and gestures may be easily implemented therein, and thus, the applications thereof have been increased. In particular, implementing a multi-touch interface may be easier in capacitive-type touchscreens than in resistive-type touchscreens, thus allowing for applications to a wide range of devices such as smartphones.

Capacitive-type touchscreens include a plurality of electrodes having a uniform pattern, in which electrodes should be formed in most regions of a touchscreen corresponding to an effective display region of a display device, and should have a uniform pattern to sense a touch input. When a touch input is received and a touch location is determined, a variation in a capacitance value may be linear with respect to the touch location, in order to implement a touchscreen panel (TSP) system having a prompt response speed and reliable low power driving. If the variation in the capacitance value is not linear with respect to the touch location, a touch error is problematically added by a difference between an actually obtained capacitance value and an interpolation value at each touch input location in a system. Also, in order to increase a touch sensing rate of a conductive pole having a small diameter, it is necessary to design a much smaller region of a unit pattern electrode according to the diameter of the conductive pole, whereas it is difficult to detect a touch input of the conductive pole having a very small diameter due to a limited number of available channel wires.

In order to solve these problems, it is necessary to design an optimal unit electrode pattern capable of improving linearity of capacitance values with respect to a touch input location and a touch sensing rate of a conductive pole having a small diameter.

### RELATED ART DOCUMENT

(Patent Document 1) Korean Patent Laid-Open Publication No. 2012-0027956
(Patent Document 2) Korean Patent Laid-Open Publication No. 2011-0079807

### SUMMARY OF THE INVENTION

In order to solve the problem of the related art, in a capacitive-type touchscreen device or touchscreen panel, a plurality of slits formed between a plurality of electrodes included in a unit sensing cell are formed in a point diagonal with respect to a point at which the plurality of electrodes intersect. Thus, a capacitance variation rate with respect to a touch input may be maintained at a high level, and a touch sensing rate may increase in a conductive pole having a small diameter by increasing slit regions. Also, an aspect of the present invention provides a touchscreen device and a touchscreen panel for securing linearity with respect to capacitance variations according to a location to which a touch input is applied and precisely detecting the touch input.

According to an aspect of the present invention, there is provided a touchscreen panel including: a plurality of first electrodes formed on a substrate and including a plurality of first unit electrodes connected to each other in a first axial direction; and a plurality of second electrodes formed on the substrate and including a plurality of second unit electrodes connected to each other in a second axial direction perpendicular to the first axial direction, wherein a plurality of slits having a curved shape are formed between the plurality of first electrodes and the plurality of second electrodes, part of the plurality of first unit electrodes and part of the plurality of second unit electrodes are included in a unit sensing cell having a rectangular shape, and a virtual slit obtained by rotating a slit formed in a direction toward a corner of the unit sensing cell from a center of the unit sensing cell by 90 degrees is identical to a slit formed in a direction toward another corner adjacent thereto.

The plurality of slits included in the unit sensing cell may have a sine wave shape in a direction toward the corner of the unit sensing cell from an intersection at which the plurality of first unit electrodes and the plurality of second unit electrodes intersect.

The plurality of slits included in the unit sensing cell may have a semi-wavelength sine wave shape in the direction toward the corner of the unit sensing cell from the intersection at which the plurality of first unit electrodes and the plurality of second unit electrodes intersect.

The plurality of slits may be provided to be parallel to the first axial direction or the second axial direction.

At least part of the plurality of first unit electrodes may protrude upwardly and the remaining part thereof may protrude downwardly with respect to the first axial direction.

At least part of the plurality of second unit electrodes may protrude rightwards and the remaining part thereof may protrude leftwards with respect to the second axial direction.

The plurality of first unit electrodes may be disposed between the plurality of second unit electrodes, and upward protruding regions of the plurality of first unit electrodes and left protruding regions of the plurality of second unit electrodes may be disposed linearly in the second axial direction.

The touchscreen panel may further include a circuit unit sequentially applying a predetermined driving signal to the plurality of first electrodes, sensing a change in capacitance in the plurality of second electrodes intersecting the plurality of first electrodes to which the predetermined driving signal is applied, and determining a touch input.

According to another aspect of the present invention, there is provided a touchscreen device including: a panel unit including a plurality of unit sensing cells including two or more electrodes and having a rectangular shape; and a circuit unit electrically connected to the plurality of unit sensing cells and determining a touch input, wherein each of the plurality of unit sensing cells includes a plurality of slits having a curved shape, and a virtual slit obtained by rotating a slit formed in a direction toward a corner of the unit sensing cell from a center of the unit sensing cell by 90 degrees is identical to a slit formed in a direction toward another corner adjacent thereto.

Each of the plurality of unit sensing cells may include a first electrode and a second electrode intersecting with respect to the center of the unit sensing cell.

The first electrode and the second electrode included in each of the plurality of unit sensing cells may be connected to a first electrode and a second electrode included in another adjacent unit sensing cell.

The first electrode included in each of the plurality of unit sensing cells may be connected to the first electrode included in another adjacent unit sensing cell in a first axial direction, and the second electrode included in each of the plurality of unit sensing cells may be connected to the second electrode included in another adjacent unit sensing cell in a second axial direction.

The plurality of slits included in the plurality of unit sensing cells may have a sine wave shape in a direction toward any one corner of the unit sensing cell from the center of the unit sensing cell.

The plurality of slits may be provided to be parallel to the first axial direction or the second axial direction.

The circuit unit may apply a predetermined driving signal to the first electrode, sense a change in capacitance in the second electrode, and determine a touch input.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view of the exterior of an electronic device including a touchscreen device according to an embodiment of the present invention;

FIGS. 2 and 3 are plan views of a touchscreen panel according to an embodiment of the present invention;

FIG. 4 is a circuit diagram of a touch sensing device according to an embodiment of the present invention;

FIGS. 5 and 6 are diagrams for explaining slits included in electrodes of a touchscreen device according to an embodiment of the present invention; and

FIGS. 7A, 7B and 7C are comparision diagrams for explaining a touch sensing rate of a touchscreen device according to an embodiment of the present invention.

### DETAILED DESCRIPTION OF THE EMBODIMENTS

Embodiments of the present invention will be described in detail with reference to the accompanying drawings. These embodiments will be described in detail to allow those skilled in the art to practice the present invention. It should be appreciated that various embodiments of the present invention are different but do not have to be exclusive. For example, specific shapes, configurations, and characteristics described in an embodiment of the present invention may be implemented in another embodiment without departing from the spirit and the scope of the present invention. In addition, it should be understood that positions and arrangements of individual components in each disclosed embodiment may be changed without departing from the spirit and the scope of the present invention. Therefore, the detailed description described below should not be construed as being restrictive in meaning. The scope of the present invention is limited only by the accompanying claims and their equivalents, if they are appropriately described. Similar reference numerals will be used to describe elements having the same or similar functions throughout the accompanying drawings.

Hereinafter, embodiments of the present invention will be described in detail with reference to the accompanying drawings so that those skilled in the art may easily practice the present invention.

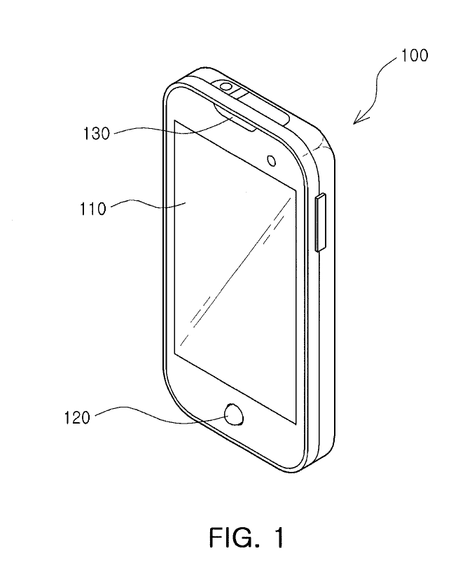

FIG. 1 is a perspective view of the exterior of an electronic device including a touchscreen device according to an embodiment of the present invention.

FIG. 1 illustrates an electronic device 100 to which a touch sensing device is applicable, according to an embodiment of the present invention. Referring to FIG. 1, the electronic device 100 of the present embodiment includes a display device 110 for outputting images, an input unit 120, and an audio unit 130 for outputting sound, and may provide the touch sensing device integrally formed with the display device 110.

As shown in FIG. 1, in a mobile device, in general, a touch sensing device is integrally formed with the display device 110. The touch sensing device needs to have a high light transmittance such that the image displayed by the display device 110 can be transmitted. Thus, the touch sensing device can be implemented by forming sensing electrodes formed of a transparent, electrically conductive material such as indium-tin oxide (ITO), indium zinc oxide (IZO), zinc oxide (ZnO), carbon nanotubes (CNTs), a conductive polymer, or graphene in a base substrate formed of a transparent film material such as polyethylene terephthalate (PET), polycarbonate (PC), polyethersulfone (PES), polyimide (PI), and the like. Alternatively, sensing electrodes having a mesh structure in which metal strips having a very thin line width are densely disposed may be formed. A wire pattern connected to the sensing electrodes formed of the transparent conductive material is disposed in a bezel region of the display device 110, and is visually shielded by the bezel region, and thus the wire pattern may be formed of a metal such as silver (Ag), copper (Cu), and the like.

In a case in which the touch sensing device according to the present embodiment is not integrally formed with the display device 110 such as in the case of a notebook computer touch pad, sensing electrodes may be patterned with a metal on a circuit substrate. For convenience of explanation, assuming a case of a touchscreen, a touch sensing device and a touch sensing method according to the present embodiment will now be described below.

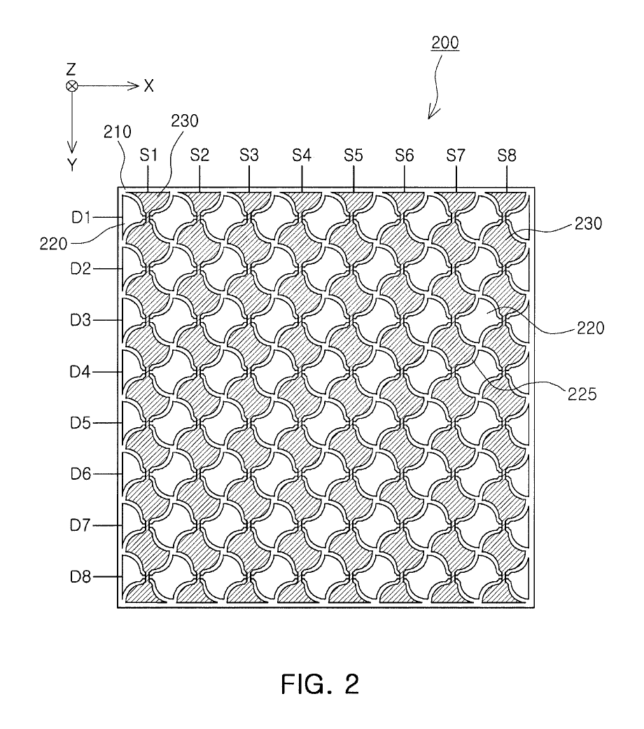

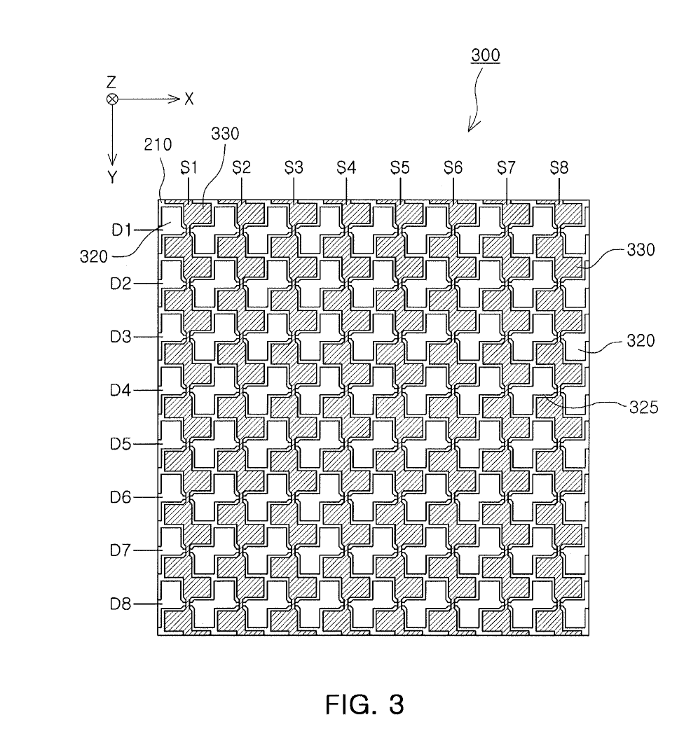

FIGS. 2 and 3 are plan views of a touchscreen panel according to an embodiment of the present invention.

Referring to FIG. 2, a touchscreen panel 200 according to the present embodiment includes a substrate 210 and a plurality of unit electrodes 220 and 230 disposed on the substrate 210. Although not shown in FIG. 2, the plurality of unit electrodes 220 and 230 may be electrically connected to a wire pattern of a circuit substrate attached to one end of the substrate 210 through a wire and a bonding pad, respectively. A controller integrated circuit (IC) may be mounted in the circuit substrate to detect a sensing signal generated by the plurality of unit electrodes 220 and 230, and determine a touch input from the sensing signal.

In a touchscreen device, the substrate 210 may be a transparent substrate in which the unit electrodes 220 and 230 are to be formed, and may be formed of a plastic material such as polyimide (PI), polymethylmethacrylate (PMMA), polyethyleneterephthalate (PET), and polycarbonate (PC) or tempered glass. Also, in addition to a region of the substrate 210 in which the unit electrodes 220 and 230 are formed, a predetermined printing region for visually shielding the wire usually formed of an opaque metallic material may be formed with respect to a region of the substrate 210 including the wire connected to the unit electrodes 220 and 230.

The plurality of unit electrodes 220 and 230 may be disposed on one side of the substrate 210 or both sides thereof, and may be formed of ITO, IZO, ZnO, CNT, graphene based material, or the like having transparent conductivity in the touchscreen device.

The plurality of unit electrodes 220 and 230 include first electrodes 220 extending in an X-axial direction and second electrodes 230 extending in a Y-axial direction. The first electrodes 220 and the second electrodes 230 may be disposed on both sides of the substrate 210 or in different substrates to intersect. In a case in which the first electrodes 220 and the second electrodes 230 are disposed on one side of the substrate 210, predetermined insulation layers may be partially formed at intersections between the first electrodes 220 and the second electrodes 230.

The controller IC may be electrically connected to the plurality of unit electrodes 220 and 230 and sense a touch input. The controller IC may sense the touch input through sensing a change in capacitance generated in the plurality of unit electrodes 220 and 230 according to the touch input. The first electrodes 220 may be connected to channels defined as D1-D8 in the controller IC and receive a predetermined driving signal. The second electrodes 230 maybe connected to channels defined as S1-S8 to be used for the touch sensing device to detect a sensing signal. In this regard, the controller IC may operate by sensing a change in mutual-capacitance generated between the first and second electrodes 220 and 230 as the sensing signal, sequentially applying the driving signal to the first electrodes 220, and simultaneously sensing a change in capacitance from the second electrodes 230.

In the present embodiment, the plurality of unit electrodes 220 and 230 are mutually connected in the X-axial direction or in the Y-axial direction on a 2D plane that is defined as an X-Y coordinate plane and include a plurality of first electrodes and a plurality of second electrodes. The plurality of first and second electrodes are formed to substantially shield one entire side of the substrate 210 so that a plurality of slits 225 having very small widths are formed between the plurality of first and second electrodes.

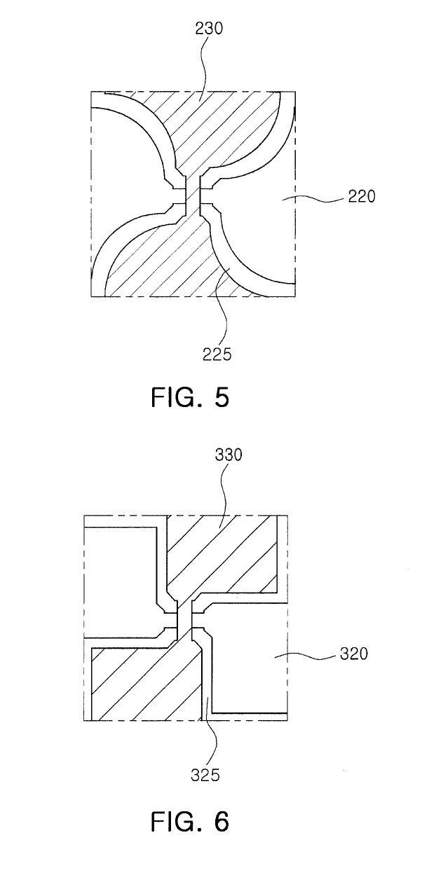

A unit sensing cell including at least one of the unit electrodes 220 and 230 may be defined. The unit sensing cell may have a rectangular shape as shown in FIG. 5, and include one or more unit electrodes 220 and 230. Also, a single unit sensing cell may include one or more first electrodes extending in the X axial direction and one or more second electrodes extending in the Y axial direction. A center of the unit sensing cell in the rectangular shape may be an intersection at which the first electrodes extending in the X axial direction and the second electrodes extending in the Y axial direction intersect.

The first electrodes and the second electrodes may be surrounded by wave shapes. The wave shape may be a sine wave shape. The first electrodes and the second electrodes may be formed in such a manner that the plurality of slits 225 formed between the first electrodes and the second electrodes intersect to have uniform widths.

FIG. 3 is a plan view of a touchscreen panel according to an embodiment of the present invention, like FIG. 2.

Referring to FIG. 3, a touchscreen panel 300 according to the present embodiment includes the substrate 210 and a plurality of unit electrodes 320 and 330. Similarly to FIG. 2, the plurality of unit electrodes 320 and 330 may include first electrodes 320 connected in an X-axial direction and second electrodes 330 connected in a Y-axial direction. The plurality of first and second electrodes may be formed to substantially shield an entire side of the substrate 210 so that a plurality of slits 325 having very small widths are formed between the plurality of first electrodes and the plurality of second electrodes.

The touchscreen panel 300 of FIG. 3 may operate similarly to the touchscreen panel 200 of FIG. 2. That is, a controller IC (not shown) may sequentially apply a driving signal to the first electrodes connected to the channels D1-D8, sense a change in mutual-capacitance from the second electrodes, and determine a touch input.

The first unit electrodes 320 have a shape in which at least part of the first unit electrodes 320 protrude upwardly and the remaining part thereof protrude downwardly in the X axial direction. The second unit electrodes 330 have a shape in which at least part of the first unit electrodes 320 protrude leftwards and the remaining part thereof protrude rightwards. Also, the first unit electrodes 320 are disposed between the second unit electrodes 330. Upward protruding regions of the first unit electrodes 320 and left protruding regions of the second unit electrodes 330 may be disposed linearly in the Y axial direction.

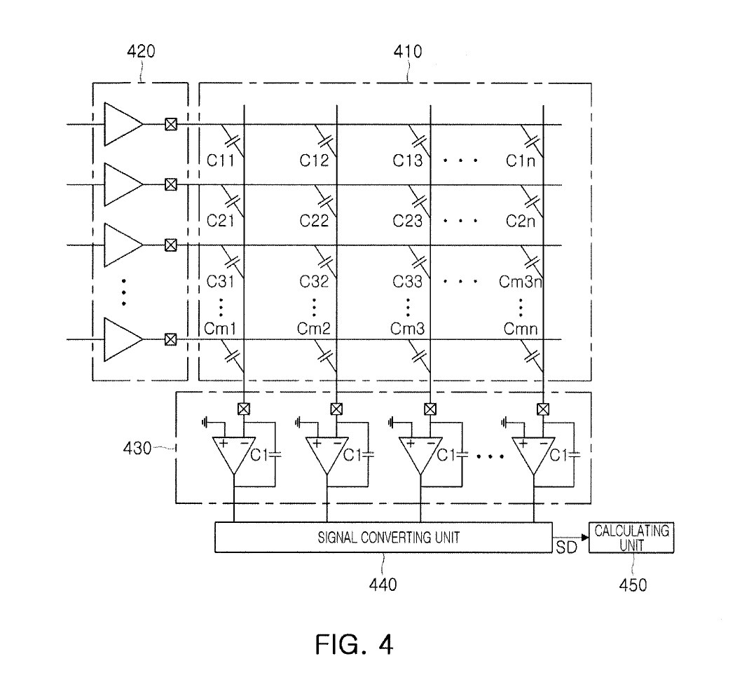

FIG. 4 is a circuit diagram of a touch sensing device according to an embodiment of the present invention.

Referring to FIG. 4, a touch sensing device according to the present embodiment includes a panel unit 410, a driving circuit unit 420, a sensing circuit unit 430, a signal converting unit 440, and a calculating unit 450. The panel unit 410 includes a plurality of first electrodes extending in a first axial direction—a verticla direction of FIG. 4—and a plurality of second electrodes extending in a second axial direction perpendicular to the first axial direction—a horizontal direction of FIG. 4. Changes in capacitance C11-Cₘₙ occur at a pluraltiy of nodes at which the first electrodes and the second electrodes intersect. The changes in capacitance C11-Cₘₙ occuring at the pluraltiy of nodes may be changes in mutual-capaictance generated by a driving signal applied to the first electrodes by the driving cirucit unit 420. Meanwhile, the driving circuit unit 420, the sensing circuit unit 430, the signal converting unit 440, and the calculating unit 450 may be implemented as a single IC.

The driving circuit unit 420 applies a predetermined driving signal to the first electrodes of the panel unit 410. The driving signal may be a square wave signal, a sine wave signal, and a triangle wave signal having a predetermined period and amplitude, and may be sequentially applied to each of the plurality of first electrodes. Although FIG. 4 shows that circuits for generating and applying the driving signal are respectively connected to the plurality of first electrodes, a single diriving signal generating circuit may be provided to apply the driving signal to the plurality of first electrodes by using a swithcing circuit.

The sensing circuit unit 430 may include an integral circuit to sense the changes in capacitance C11-Cₘₙ from the second electrodes. The integral circuit may include at least one operational amplifier and a capacitor C1 having a predetermined capacitance. An inversion input terminal of the operational amplifier is connected to the second electrodes to convert the changes in capacitance C11-Cₘₙ into an analog signal such as a voltage signal and output the convered signal. In a case in which the driving signal is sequentially applied to the plurality of first electrodes, the changes in capacitance C11-Cₘₙ may be simultaneously detected from the plurality of second electrodes, and thus the number of integral circuits may be equal to the number of second electrodes.

The signal converting unit 440 generates a digital signal S_{D} from the analog signal generated by the integral circuit. For example, the signal converting unit 440 may include a time-to-digital converter (TDC) circuit that meausures time taken for the analog signal output by the sensing circuit unit 430 in a voltage form to reach a predetermined reference voltage level and converts the measured time into the digital signal S_{D}, or an analog-to-digital converter (ADC) circuit that measures an amount by which the level of the analog signal output by the sensing circuit unit 430 is changed during a predetermined period of time and converts the measured amount into the digital signal S_{D}. The calculating unit 450 determines a touch input applied to the panel unit 410 by using the digital signal S_{D}. As an embodiment, the calculating unit 450 may determine the number of touch inputs applied to the panel unit 410, coordinates thereof, gesture motions thereof, and the like.

FIGS. 5 and 6 are diagrams illustrating a plurality of slits formed between first and second electrodes of a touchscreen device according to an embodiment of the present invention.

Referring to FIG. 5, a plurality of slits 225 may extend to a corner with respect to a point at which diagonal lines in a unit sensing cell 240 having a rectangular shape intersect, i.e., an intersection at which the first electrodes 220 and the second electrodes 230 intersect, and have a sine wave shape. To increase a touch sensing rate with respect to a conductive pole having a small diameter, the sine wave shape of the plurality of slits 225 may be a semi-wavelength sine wave. However, the present invention is not limited thereto, and the sine wave shape maybe formed to repeat various cycles. Also, the plurality of slits 225 may be formed at a point diagonal with respect to the intersection at which the first electrdoes 220 and the second electrodes 230 intersect in the unit sensing cell 240.

As described above, a capacitance variation rate of a sensing signal maybe maintained and interporation may increase by increasing regions of the plurality of slits 225 formed in the unit sensing cell 240 while maintaining a patten identity of the first electrodes and the second electrodes between the X axial direction and the Y axial direction. Also, a resolution indicating a differnece between a minimum value and a maximum value of the capacitance variation rate is enhanced, and thus being advantageous in terms of noise or multiple touches.

Referring to FIG. 6, the plurality of slits 325 may extend to a corner with respect to a point at which diagonal lines of a unit sensing cell having a rectangular shape intersect, i.e., an intersection at which the first electrodes 320 and the second electrodes 330 intersect, and be formed to be parallel to the X axial direction or the Y axial direction. That is, the plurality of slits 325 may be formed to extend parallel to the X axial direction from a point at which rectangular diagonal lines intersect to corners and arrive at a corner via a side parallel to the Y axial direction.

A virtual slit obtained by rotating a slit formed in a direction toward a corner of the unit sensing cell from a center of the unit sensing cell by 90 degrees may be identical to a slit formed in a direction toward another corner adjacent thereto.

Similar to FIG. 5, the touchscreen device including the plurality of electrodes of FIG. 6 may maintain a capacitance variation rate of a sensing singal and increase interporation by increasing regions of the plurality of slits formed in the unit sensing cell while maintaining a patten identity of the first electrodes and the second electrodes between the X axial direction and the Y axial direction. Also, a resolution indicating a differnece between a minimum value and a maximum value of the capacitance variation rate is enhanced, and thus being advantageous in terms of noise or multiple touches.

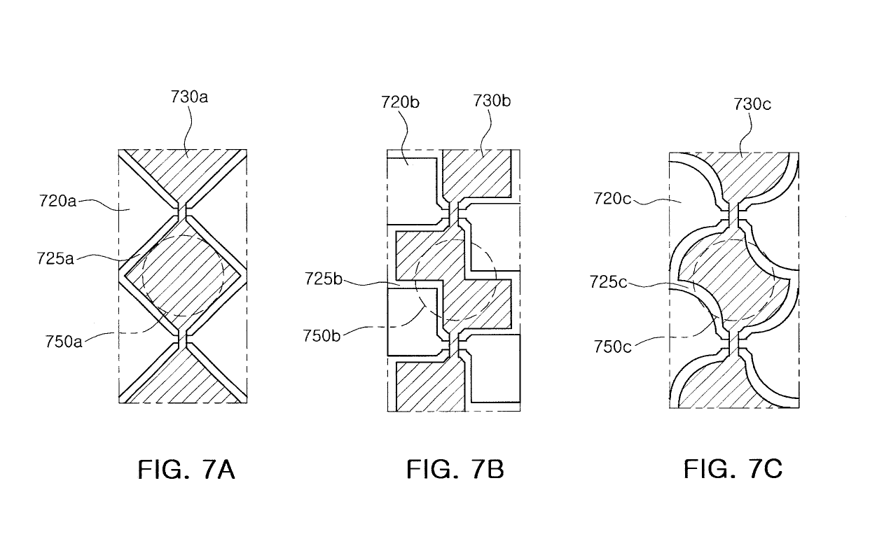

FIGS. 7A, 7B and 7C are comparision diagrams illustrating a touch sensing rate of a conductive pole having a small diameter with respec to shapes of unit electrodes according to an embodiment of the present invention. FIG. 7A shows part of a touchscreen panel including unit electrodes having diamond shapes according to the prior art. FIGS. 7B and 7C show part of a touchscreen panel including unit electrodes according to an embodiment of the present invention.

Referring to FIG. 7A, in the conductive pole having a small diameter, a contact area 750a of the conductive pole may be included in a second unit electrode 730a. In a case in which a slit 725a is not included in the contact area 750a of the conductive pole, that is, part of a first unit electrode 720a and a second unit electrode 730a is not included, a capacitance variation rate detected from the second electrode is low, which may lower a touch sensing rate of the conductive pole.

Meanwhile, FIGS. 7B and 7C show the touchscreen panel contacting the conductive pole having the same area in the same location as the contact area 750a of the conductive pole of FIG. 7A. Referring to FIGS. 7B and 7C, although the touchscreen panel contacts the conductive pole having the same area in the same location as shown in FIG. 7A, areas of slits 725b and 725c included in a contact area increase, as compared to FIG. 7A.

That is, the touchscreen panel according to the embodiment of the present invention has a large amount of slits, thereby increasing a touch sensing rate by greatly increasing a capacitance variation rate even in the case that a conductive pole having a small diameter contacts the touchscreen panel in an arbitrary location.

As set forth above, according to embodiments of the invention, there can be provided a touchscreen device and a touchscreen panel for increasing a touch sensing rate of a conductive pole having a small diameter while greatly maintaining a capacitance variation rate with respect to a sensing signal, by forming a plurality of slits between electrodes having a uniform repetitive pattern and increasing regions of the slits, and securing linearity with respect to a variation in capacitance according to a location to which a touch input is applied and precisely detecting the touch input.

While the present invention has been shown and described in connection with the embodiments, it will be apparent to those skilled in the art that modifications and variations can be made without departing from the spirit and scope of the invention as defined by the appended claims.

What is claimed is:

1. A touchscreen panel comprising:
a plurality of first electrodes formed on a substrate and including a plurality of first unit electrodes connected to each other in a first axial direction; and
a plurality of second electrodes formed on the substrate and including a plurality of second unit electrodes connected to each other in a second axial direction perpendicular to the first axial direction,
wherein a plurality of slits having a curved shape are formed between the plurality of first electrodes and the plurality of second electrodes,
part of the plurality of first unit electrodes and part of the plurality of second unit electrodes are included in a unit sensing cell having a rectangular shape, and
a virtual slit obtained by rotating a slit formed in a direction toward a corner of the unit sensing cell from a center of the unit sensing cell by 90 degrees is identical to a slit formed in a direction toward another corner adjacent thereto.

2. The touchscreen panel of claim 1, wherein the plurality of slits included in the unit sensing cell have a sine wave shape in a direction toward the corner of the unit sensing cell from an intersection at which the plurality of first unit electrodes and the plurality of second unit electrodes intersect.

3. The touchscreen panel of claim 2, wherein the plurality of slits included in the unit sensing cell have a semi-wavelength sine wave shape in the direction toward the corner of the unit sensing cell from the intersection at which the plurality of first unit electrodes and the plurality of second unit electrodes intersect.

4. The touchscreen panel of claim 1, wherein the plurality of slits are provided to be parallel to the first axial direction or the second axial direction.

5. The touchscreen panel of claim 4, wherein at least part of the plurality of first unit electrodes protrude upwardly and the remaining part thereof protrude downwardly with respect to the first axial direction.

6. The touchscreen panel of claim 5, wherein at least part of the plurality of second unit electrodes protrude rightwards and the remaining part thereof protrude leftwards with respect to the second axial direction.

7. The touchscreen panel of claim 6, wherein the plurality of first unit electrodes are disposed between the plurality of second unit electrodes, and
upward protruding regions of the plurality of first unit electrodes and left protruding regions of the plurality of second unit electrodes are disposed linearly in the second axial direction.

8. The touchscreen panel of claim 1, further comprising a circuit unit sequentially applying a predetermined driving signal to the plurality of first electrodes, sensing a change in capacitance in the plurality of second electrodes intersecting the plurality of first electrodes to which the predetermined driving signal is applied, and determining a touch input.

9. A touchscreen device, comprising:
a panel unit including a plurality of unit sensing cells including two or more electrodes and having a rectangular shape; and
a circuit unit electrically connected to the plurality of unit sensing cells and determining a touch input,
wherein each of the plurality of unit sensing cells includes a plurality of slits having a curved shape, and
a virtual slit obtained by rotating a slit formed in a direction toward a corner of the unit sensing cell from a center of the unit sensing cell by 90 degrees is identical to a slit formed in a direction toward another corner adjacent thereto.

10. The touchscreen device of claim 9, wherein each of the plurality of unit sensing cells includes a first electrode and a second electrode intersecting with respect to the center of the unit sensing cell.

11. The touchscreen device of claim 10, wherein the first electrode and the second electrode included in each of the plurality of unit sensing cells are connected to a first electrode and a second electrode included in another adjacent unit sensing cell.

12. The touchscreen device of claim 11, wherein the first electrode included in each of the plurality of unit sensing cells is connected to the first electrode included in another adjacent unit sensing cell in a first axial direction, and
the second electrode included in each of the plurality of unit sensing cells is connected to the second electrode included in another adjacent unit sensing cell in a second axial direction.

13. The touchscreen device of claim 9, wherein the plurality of slits included in the plurality of unit sensing cells have a sine wave shape in a direction toward any one corner of the unit sensing cell from the center of the unit sensing cell.

14. The touchscreen device of claim 12, wherein the plurality of slits are provided to be parallel to the first axial direction or the second axial direction.

15. The touchscreen device of claim 11, wherein the circuit unit applies a predetermined driving signal to the first electrode, senses a change in capacitance in the second electrode, and determines a touch input.
